(19) United States
(12) Patent Application Publication
(10) Pub. No.: US 2016/0300079 A1
(43) Pub. Date: Oct. 13, 2016

(54) Method and Device for Processing Hidden File Folder, and Terminal

(71) Applicant: ZTE CORPORATION, Shenzhen (CN)

(72) Inventor: Xuanhui GONG, Shenzhen (CN)

(21) Appl. No.: 14/916,762

(22) PCT Filed: Oct. 18, 2013
(86) PCT No.: PCT/CN2013/085514

§ 371 Date: Jun. 2, 2016

(30) Foreign Application Priority Data
Sep. 6, 2013 (CN) 201310405655.2

(51) Int. Cl. G06F 21/62; G06F 17/30

(52) U.S. Cl. CPC G06F 21/6281; G06F 17/30115

(57) ABSTRACT

Provided are a method, device for processing a hidden file folder, and a terminal. The method comprises that: an application icon to which the hidden file folder is attached is determined; the hidden file folder is created in a manner that the hidden file folder shares the application icon with a first application corresponding to the application icon, wherein a unlocking path used for visiting the first application is different from a unlocking path used for visiting the hidden file folder; and a private application to be hidden is stored in the hidden file folder. The problem that a private application of a user is hidden quickly without affecting usual use is solved by the present disclosure, thus implementing the effect of quickly and concisely protecting the privacy of the user.

### TECHNICAL FIELD

The present disclosure relates to the field of communications, particularly to a method, device for processing a hidden file folder, and a terminal.

### BACKGROUND

As smart phones are becoming more and more popular nowadays, the performance of the smart phones are also improved continually, accompanied by the emergence of various applications supporting different services. Many services that can be originally operated only on computers have been gradually transferred to be operated on mobile phones. In a sense, mobile phones are functioning as small-sized personal computers. An “intelligent and mobile era” is developing in such a rapid manner to bring great use convenience to users. However, people find that personal privacy is exposed in such convenience again while exclaiming at the rapid development of science and technology.

Users today are paying more and more attention to protection of personal privacy when using smart phones, and most people do not like others to know information on their mobile phones, especially when some application software related to personal privacy or property security are installed on the mobile phones. The users always hope that financial loss or other losses caused by other people who intentionally or unintentionally view or use these software can be avoided. However, during a real communication, the mobile phones sometimes may be inevitably borrowed and used by others as tools for purposes of calls or gaming and web surfing. The users may have suffered inevitable leakage of private information in such a scenario.

Therefore, information that needs to be kept secret cannot be hidden quickly in the related art, thus causing leakage of private information.

### SUMMARY

The present disclosure provides a method, device for processing a hidden file folder, and a terminal, so as to at least solve the problem that information that needs to be kept secret cannot be hidden quickly and leakage of private information is caused in the related art.

According to an embodiment of the present disclosure, a method for processing a hidden file folder is provided, comprising: determining an application icon to which the hidden file folder is to be attached; creating the hidden file folder in a manner that the hidden file folder shares the application icon with a first application corresponding to the application icon, wherein an unlocking path used for visiting the first application is different from an unlocking path used for visiting the hidden file folder; and storing in the hidden file folder a private application to be hidden.

In an example embodiment, storing in the hidden file folder the private application to be hidden comprises: selecting the private application to be hidden; judging whether a hiding function is activated; and when a judging result is that the hiding function is activated, storing in the hidden file folder the private application to be hidden.

In an example embodiment, wherein judging whether the hiding function is activated comprises: receiving an input path; judging whether the input path is matched with a preset activating path; and when a judging result is that the input path is matched with the preset activating path, determining that the hiding function is activated.

In an example embodiment, after creating the hidden file folder in a manner that the hidden file folder shares the application icon with a first application corresponding to the application icon, further comprising: setting an unlocking path for visiting other applications, wherein said other applications are applications corresponding to application icons except the application icon shared by the first application and the hidden file folder.

In an example embodiment, after creating the hidden file folder in a manner that the hidden file folder shares the application icon with a first application corresponding to the application icon, further comprising: respectively deleting the first application or the hidden file folder according to different security locks, wherein the private application stored in the hidden file folder is recovered when the hidden file folder is deleted.

According to another aspect of the present disclosure, a device for processing a hidden file folder is provided, comprising: a determining component, configured to determine an application icon to which the hidden file folder is attached; a creating component, configured to create the hidden file folder in a manner that the hidden file folder shares the application icon with a first application corresponding to the application icon, wherein a unlocking path used for visiting the first application is different from a unlocking path used for visiting the hidden file folder; and a storing component, configured to store in the hidden file folder a private application to be hidden.

In an example embodiment, wherein the storing component comprises: a selecting element, configured to select the private application to be hidden; a judging element, configured to judge whether a hiding function is activated; and a storing element, configured to, when a judging result is that the hiding function is activated, store in the hidden file folder the private application to be hidden.

In an example embodiment, wherein the judging element comprises: a receiving sub-element, configured to receive an input path; a judging sub-element, configured to judge whether the input path is matched with a preset activating path; and a determining sub-element, configured to, when a judging result is that the input path is matched with the preset activating path, determine that the hiding function is activated.

In an example embodiment, further comprising: a setting component, configured to set an unlocking path for visiting other applications, wherein said other applications are applications corresponding to application icons except the application icon shared by the first application and the hidden file folder.

In an example embodiment, further comprising: a deleting component, configured to, respectively delete the first application or the hidden file folder according to different security locks, wherein the private application stored in the hidden file folder is recovered when the hidden file folder is deleted.

According to another aspect of the present disclosure, a terminal is provided, comprising the device as claimed in any one of claims 6 to 10.

According to the present disclosure, an application icon to which a hidden file folder is attached is determined; the hidden file folder is created in a manner that the hidden file folder shares the application icon with a first application corresponding to the application icon, wherein a unlocking path used for visiting the first application is different from a unlocking path used for visiting the hidden file folder; and a private application to be hidden is stored in the hidden file folder, thus the problem that a private application of a user is hidden quickly without affecting usual use is solved, further implementing the effect of quickly and concisely protecting the privacy of the user.

### BRIEF DESCRIPTION OF THE DRAWINGS

The accompanying drawings illustrated herein are used for providing further understanding to the present disclosure and constitute a part of the present application. The schematic embodiments of the present disclosure and description thereof are used for explaining the present disclosure, instead of constituting improper limitation to the present disclosure. In the accompanying drawings:

FIG. 1 is a flowchart of a method for processing a hidden file folder according to an embodiment of the present disclosure;

FIG. 2 is a structural block diagram of a device for processing a hidden file folder according to an embodiment of the present disclosure;

FIG. 3 is a structural block diagram of a device for creating and storing a hidden file folder according to an embodiment of the present disclosure;

FIG. 4 is a preferred structural block diagram of a judging element 34 in a device for creating and storing a hidden file folder according to an embodiment of the present disclosure;

FIG. 5 is the first preferred structural diagram of a device for processing a hidden file folder according to an embodiment of the present disclosure;

FIG. 6 is the second preferred structural diagram of a device for processing a hidden file folder according to an embodiment of the present disclosure;

FIG. 7 is a structural block diagram of a terminal according to an embodiment of the present disclosure;

FIG. 8 is a schematic diagram of a method of access/activation using “different paths” based on an “access control pattern lock” according to an embodiment of the present disclosure;

FIG. 9 is a schematic diagram of an access/activation method based on “gesture recognition” according to an embodiment of the present disclosure;

FIG. 10 is a structural block diagram of a device for quickly hiding a private application according to a preferred embodiment of the present disclosure; and

FIG. 11 is a flowchart of sequential processing of quickly hiding a private application according to an embodiment of the present disclosure.

### DETAILED DESCRIPTION OF THE EMBODIMENTS

The present disclosure will be expounded hereinafter with reference to the accompanying drawings and in combination with the embodiments. It needs to be noted that the embodiments in the present application and the characteristics in the embodiments may be combined with each other if there if no conflict.

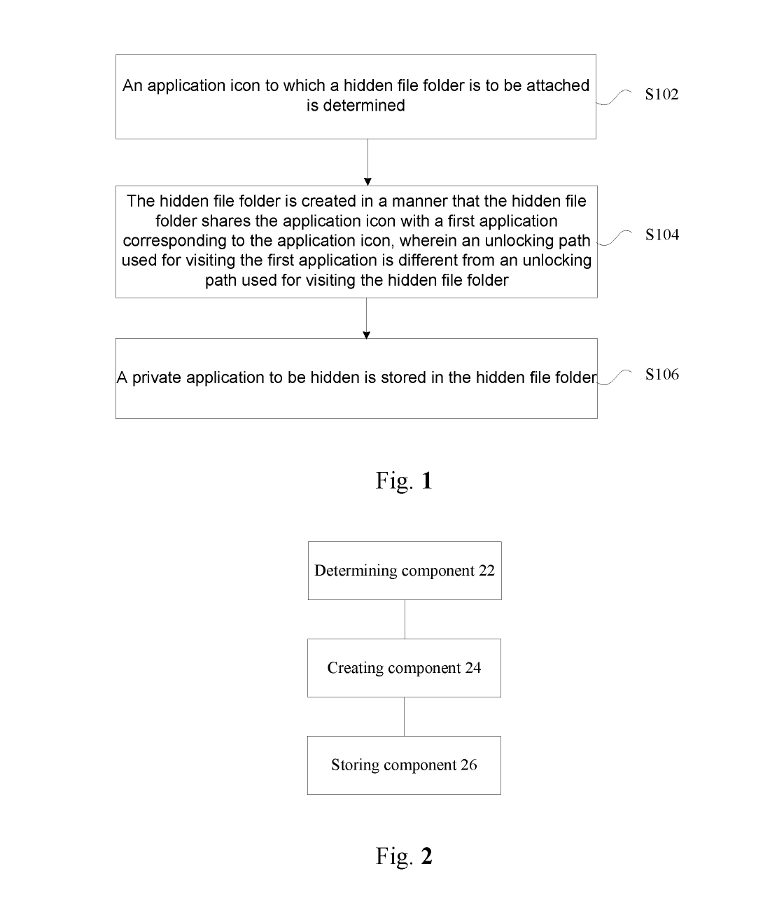

A method for quickly hiding a private application of a user without affecting usual use is provided in the present embodiment. FIG. 1 is a flowchart of a method for processing a hidden file folder according to an embodiment of the present disclosure. As shown in FIG. 1, the flow comprises the following steps.

Step 102: An application icon to which the hidden file folder is attached is determined.

Step 104: The hidden file folder is created in a manner that the hidden file folder shares the application icon with a first application corresponding to the application icon, wherein a unlocking path used for visiting the first application is different from a unlocking path used for visiting the hidden file folder.

Step 106: A private application to be hidden is stored in the hidden file folder.

Through the above steps, user privacy is protected by setting the hidden file folder. Compared with the related art in which leakage of private information is caused because the information that needs to be kept secret cannot be hidden quickly, or user privacy cannot be protected quickly and conveniently because protection that requires complex privacy programs is not only complicated, but also time consuming, the hidden file folder is set to bring effects of convenience, speediness and high efficiency, thus greatly improving user experience.

In an example embodiment, when the private application to be hidden is stored in the hidden file folder, one or more hidden files that need to be added to the hidden file folder may be dragged, so as to drag the one or more hidden files to the hidden file folder. Preferably, the following processing method may be also adopted: firstly, the private application to be hidden is selected; whether a preset hiding function is judged; and when a judging result is that the hiding function is activated, i.e. the hiding function is in an activated state, the selected private application to be hidden is stored in the hidden file folder. A large number of hidden applications are processed massively by using such processing.

It needs to be noted that whether the hiding function activated may be judged by using a plurality of processing methods. For example, a password, such as a simple numerical password, may be set directly, relatively safe and reliable combination passwords of various types may be also applied, or a processing method of an input path may be also applied, wherein the input path may be an path obtained by the following manner: the application icon to which the hidden file folder is attached is used as an initial point of the path; after the application icon is pressed long, a draggable function is implemented on the application icon, and the path is inputted by using the application icon as an initial point. Whether the input path is matched with a preset activating path is judged; and when a judging result is that the input path is matched with the preset activating path, it is determined that the hiding function is activated. The hiding function may be also activated by the path by using a grid-like unlocking method, i.e. the activating path is implemented in a 3×3 grid or a 4×4 grid, or other similar grids. The hiding function may be also activated by a gesture, i.e. the hiding function is activated by a path in a free graph. Such a method breaks through the imprisonment on a conventional path which is necessarily a straight line, so that the activating path is set in a more free and human-oriented manner. Such processing is fast and efficient with good secrecy performance. The path for activating the hiding function may be inputted without dragging the application icon, i.e. the application icon to which the hidden file folder is attached is clicked, a grid unlocking interface will emerge, and a path is inputted, and the hiding function of the hidden file folder is activated when the inputted path is matched with the preset activating path.

The following processing may be further performed after the hidden file folder is created in a manner that the hidden file folder shares the application icon with a first application corresponding to the application icon so as to further implement the hiding function: an unlocking path for visiting other applications is set, wherein said other applications are applications corresponding to application icons except the application icon shared by the first application and the hidden file folder. In other words, unlocking paths are further set for other applications besides the unlocking paths are set for the first application and the hidden file folder. For example, the same unlocking path may be set for visiting other applications and the first application. Through the above processing, it makes more possible for a guarded person to visit the first application or other applications when operating the application icon. For example, both the first application and other applications may be visited by using the same icon. An unlocking path which is the same as the unlocking path of other applications is inputted when the icon shared by the first application and the hidden file folder is clicked, so as to visit the first application directly. A user is unaware of the existence of the hidden file folder, thereby reducing the possibility of visiting the hidden folder to a certain degree. Therefore, the hidden file folder is hidden and protected to a certain degree. Of course, a different unlocking path which is different from the unlocking path used for visiting the hidden file folder, may be also set for other applications. In this way, the hidden file folder may be also hidden and protected in the same way. The function may be set selectively according to a preference of a user.

After the hidden file folder is created in a manner that the hidden file folder shares the application icon with a first application corresponding to the application icon, in order to implement good user experience, the hidden file folder may be visited according to different unlocking paths set above when the hidden file folder is visited, so as to access private applications after the hidden file folder is visited, and the private applications in the hidden file folder may be also recovered when the hidden file folder does not need to be used while the applications and the hidden file folder may be also deleted according to different security locks when hiding function is not necessary. It needs to be noted that the private application stored in the hidden file folder is recovered when the hidden file folder is deleted, thus facilitating function selection.

A device for processing a hidden file folder is further provided in the present embodiment. The device is configured to implement the foregoing embodiments and preferred embodiments, and what has been described will not be repeated. As used below, the term “component” may implement a combination of software and/or hardware having a specific function. Although the device described in the following embodiment is preferably implemented by software, implementation using hardware or a combination of software and hardware is also possible and conceivable.

FIG. 2 is a structural block diagram of a device for processing a hidden file folder according to an embodiment of the present disclosure. As shown in FIG. 2, the device includes a determining component 22, a creating component 24 and a storing component 26. The device will be described below.

The determining component 22 is configured to determine an application icon to which the hidden file folder is attached; the creating component 24 is connected to the determining component 22 and configured to create the hidden file folder in a manner that the hidden file folder shares the application icon with a first application corresponding to the application icon, wherein a unlocking path used for visiting the first application is different from a unlocking path used for visiting the hidden file folder; and the storing component 26 is connected to the creating component 24 and configured to store in the hidden file folder a private application to be hidden.

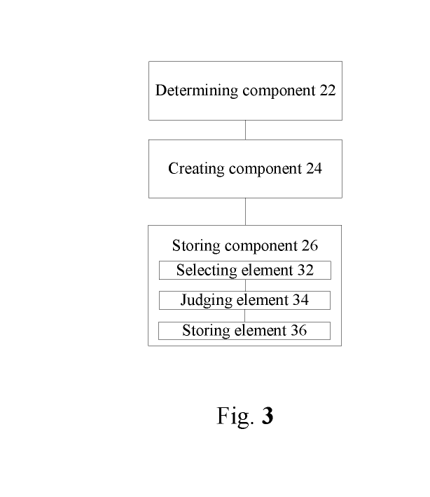

FIG. 3 is an example structural block diagram of the storing component 26 in the device for processing the hidden file folder according to an embodiment of the present disclosure. As shown in FIG. 3, the storing component 26 includes a selecting element 32, a judging element 34 and a storing element 36. The storing component 26 will be described below.

The selecting element 32 is configured to select the private application to be hidden; the judging element 34 is connected to the selecting element 32 and configured to judge whether a hiding function is activated; and the storing element 36 is connected to the judging element 34 and configured to, when a judging result is that the hiding function is activated, store in the hidden file folder the private application to be hidden.

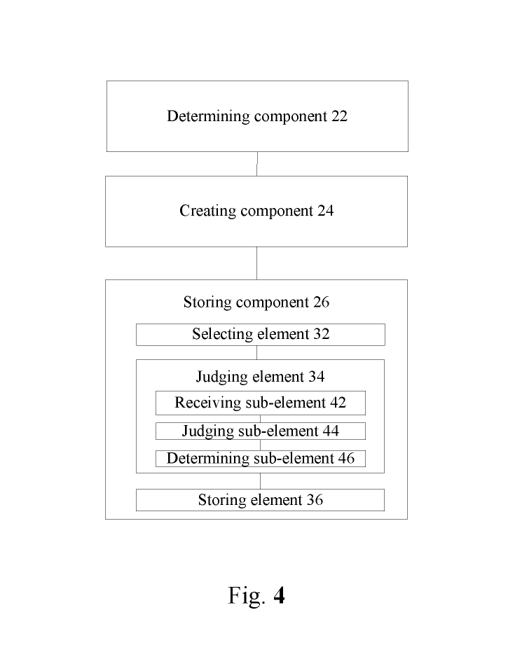

FIG. 4 is an example structural block diagram of the judging element 34 in the storing component 26 in the device for processing the hidden file folder according to an embodiment of the present disclosure. As shown in FIG. 4, the judging element 34 includes a receiving sub-element 42, a judging sub-element 44 and a determining sub-element 46. The judging element 34 will be described below.

The receiving sub-element 42 is configured to receive an input path; the judging sub-element 44 is connected to the receiving sub-element 42 and configured to judge whether the input path is matched with a preset activating path; and the determining sub-element 46 is connected the judging sub-element 44 and configured to, when a judging result is that the input path is matched with the preset activating path, determine that the hiding function is activated.

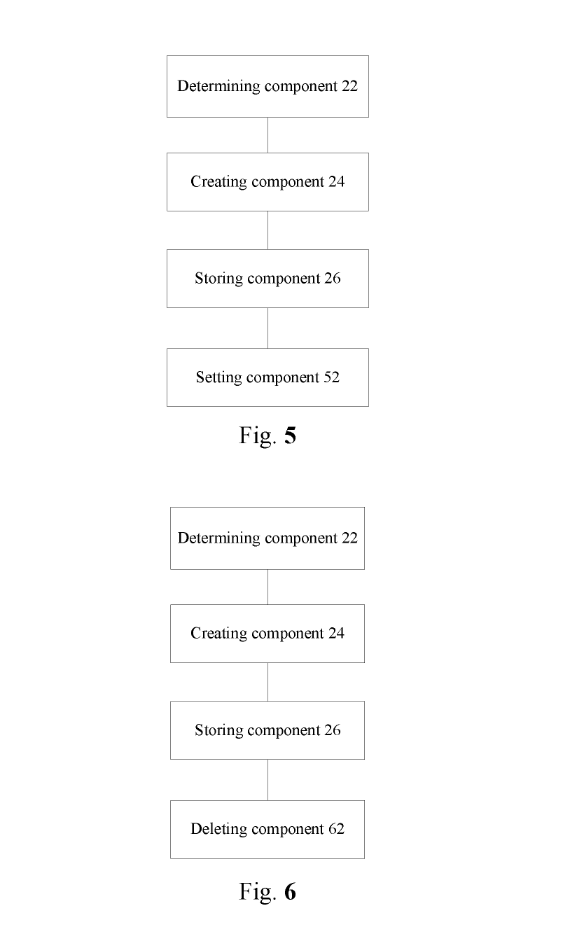

FIG. 5 is the first example structural diagram of the device for processing the hidden file folder according to an embodiment of the present disclosure. As shown in FIG. 5, besides all components as shown in FIG. 2, the device further includes a setting component 52. The setting component 52 will be described below.

The setting component 52 is connected to the storing component 26 and configured to set an unlocking path for visiting other applications, wherein said other applications are applications corresponding to application icons except the application icon shared by the first application and the hidden file folder.

FIG. 6 is the second example structural diagram of the device for processing the hidden file folder according to an embodiment of the present disclosure. As shown in FIG. 6, besides all components as shown in FIG. 2, the device further includes a deleting component 62. The deleting component 62 will be described below.

The deleting component 62 is connected to the storing component 26 and configured to respectively delete the first application or the hidden file folder according to different security locks, wherein the private application stored in the hidden file folder is recovered when the hidden file folder is deleted.

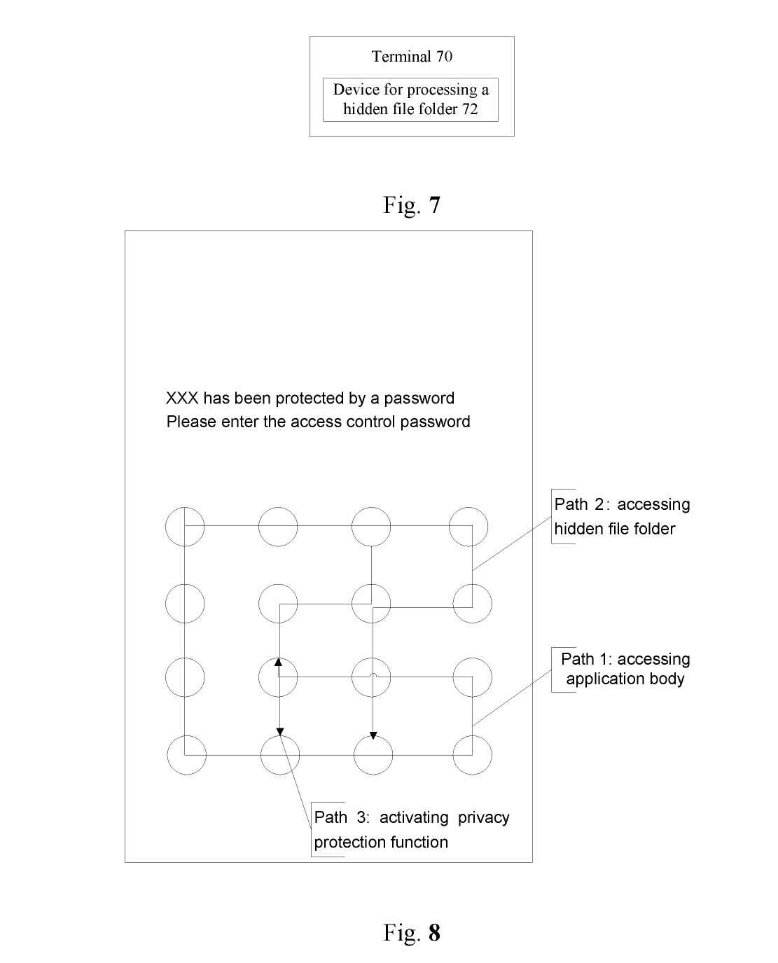

FIG. 7 is a structural block diagram of a terminal according to an embodiment of the present disclosure. As shown in FIG. 7, the terminal 70 includes any one of the devices for processing the hidden file folder 72 described above.

It needs to be noted that the embodiments and example embodiments above apply different paths to slide to unlock and access a hidden file folder and an application body to which the hidden file folder is attached. Similarly, the hidden file folder and the application body to which the hidden file folder is attached may be also accessed respectively by setting different numerical passwords, letter passwords, Chinese character passwords, or combination passwords thereof. A variety of accessing and unlocking methods may be provided for the hidden file folder. Besides the method above, an application icon to which the hidden file folder is attached may be also clicked, and an unlocking path is set in a grid that emerges. The application icon to which the hidden file folder is attached may be also pressed long so as to set a path by using the icon as an initial point of the path. A form of the path, which may be set freely, is not limited to a common straight line.

It also needs to be pointed out that the unlocking path for accessing the hidden file folder, the unlocking path for accessing the application body to which the hidden file folder is attached, and the path for activating the hiding function of the hidden file folder in the embodiments and preferred embodiments above are three separate unlocking paths and the three paths are different.

It can be hardly ensured in the related art that a user of a mobile phone fails to quickly and conveniently hide/recover his/her private application within a short period of time while making others difficult to be aware of an entry for protecting the application, thus a concept of a “hidden file folder” is proposed in the present embodiment. The major distinction between the file folder and other ordinary files in a system of a mobile phone is that the file folder does not have an application interface of its own. However, the file folder may be attached to any application interface on a desktop of the mobile phone. In other words, the “hidden file folder” may share the same application interface with any desktop application. A user may select any application icon already existing on the desktop of the mobile phone from a setting menu of the system as an icon of the hidden file folder. After the setting of the user, the system will map the location of the application and the icon to the “hidden file folder”. The system will create an empty file folder by creating a common file folder, and a location and an icon thereof are the location and the icon of the designated application respectively, thereby ensuring that only the user knows the location of the “hidden file folder” while others are unaware of the existence of the file folder.

The “hidden file folder” may serve as a management file folder of “private applications”. The user may manage his/her private applications in the file folder, and perform a series of operations including addition, deletion, and recovery and so on of a “private application”.

A method of “access using different paths” of an “access control pattern lock” is used in the present embodiment so that two different application entities may be visited by one application interface. The “access control pattern lock” is used for protecting the privacy of an application in a general application scenario. When the user needs to access a specific “private application”, the user needs to slide on a screen to input an unlocking path, and the application can be opened only when the unlocking path is matched with a preset path. For example, two additional unlocking paths, one of which is used for accessing the “hidden file folder” and the other one is used for activating a privacy protection function, may be added to the basic unlocking path for accessing the application body by using the “access control pattern lock”, wherein the following operations need to be performed when the hidden file folder or the application body to which the hidden file folder is attached is accessed: when the user sets a icon of an application as an icon to which the “hidden file folder” is attached, the “access control lock” is turned on for the application by default. In the meanwhile, it is necessary to guide the user to set a different unlocking path for the application body and the “hidden file folder” respectively. After the path for accessing the “hidden file folder” is activated in future use, the user can access the “hidden file folder”. In brief, “access using different paths” means that different entities are visited by two different access paths by using an application icon as an entry.

The user only needs to designate several more unrelated applications as common access control applications so as to prevent location of the file folder from being known by others due to the emergence of a combination lock.

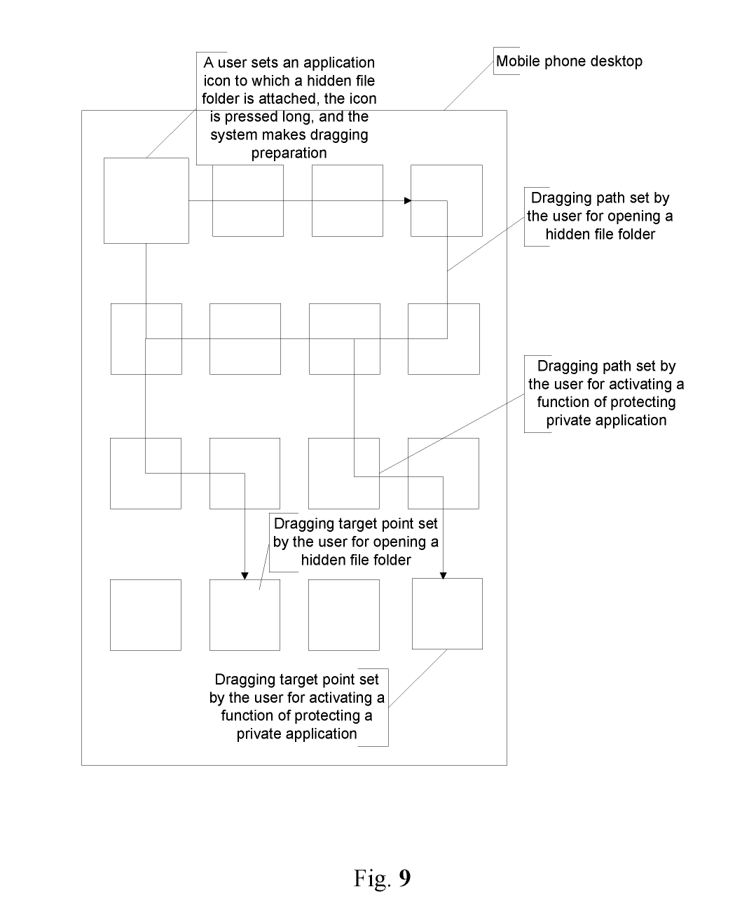

In a general file folder operation, the user needs to drag application icons one by one into a file folder, thus linearly increasing the complexity of the operation with the increase of the number of files. A “drag hiding” function for rapidly absorbing/releasing an application may be added to the “hidden file folder” so as to simplify the operation of the user and rapidly drag a file into the “hidden file folder” to be hidden. FIG. 8 is a schematic diagram of a method of access/activation using “different paths” based on an “access control pattern lock” according to an embodiment of the present disclosure and FIG. 9 is a schematic diagram of an access/activation method based on “gesture recognition” according to an embodiment of the present disclosure. The user can better understand a method for hiding a hidden file folder and a method for turning on a rapid absorbing function of a hidden file folder with the help of FIG. 8 and FIG. 9.

Specific steps set in advance are as follows: an option of a function of “activating drag hiding” is provided to a user in a system menu; after the user clicks on the option, the system displays an image of a 3×3 grid or a 4×4 grid, and identifies, on the image of the grid, the location of an application icon to which a “hidden file folder” is attached on a separate screen where the application icon locates, and then guides the user to designate a path for activating a hiding function by using the location as an initial point. In another option of the system menu, the user is guided to set a private application that the user needs to protect.

When privacy protection is required, the application icon to which the “hidden file folder” is attached is pressed long to activate a function of dragging the icon. If the icon is dragged and randomly placed at any location on a screen, there is no difference from dragging a common icon. However, if the user drags the icon to a specific screen location according to the designated path, an application absorbing function of the “hidden file folder” will be activated. At the moment, the locations of icons on the whole mobile phone desktop will be stored, while icons of private applications will, by means of an animation of “being absorbed”, fly into the application icon to which the “hidden file folder” is attached. After the animation ends, icons are rearranged orderly on the desktop, so that the screen is not in disorder.

After the operations above are performed quickly and concisely, all private applications on the desktop are hidden without any clues that can be seen by other mobile phone visitors.

The user may access the “hidden file folder” by means of sliding to unlock, so as to browse a private application of the user. The user only needs to click a “recovery” option provided by the file folder when the user needs to perform a recovery operation. All private application icons will fly out of the file folder by means of an animation of “being released”. The system invokes the desktop icon locations stored last time to recover the icons of the whole desktop, and the user can see a familiar interface layout at once.

When the user needs to delete an application to which the “hidden file folder” is attached, the user needs to input a combination lock. If the user inputs a combination lock for accessing the application body, the application is deleted and the “hidden file folder” is not deleted, and the user only needs to re-designate an icon to which the “hidden file folder” is attached in a setting. When the user inputs a combination lock for accessing the “hidden file folder”, the application body is not deleted and the “hidden file folder” is deleted and the content in the file folder will be released, which is similar to invoking the “recovery” option in the file folder.

In the embodiments and preferred embodiments above, the whole flow gives adequate consideration to use experience of a user, and privacy protection can be provided quickly and concisely in use, thus satisfying a demand for privacy protection of the user in some emergency scenarios. Moreover, the flow is easy to implement and can be rapidly applied in mobile phone production.

An embodiment of the present disclosure will be described below in combination with a specific embodiment, and the method for rapidly hiding a private application includes the following steps.

Step 1: setting stage: an application icon to which a “hidden file folder” is attached is designated in a setting menu, and three access paths are set.

Step 2: setting stage: gestures (which may be also paths) for accessing the hidden file folder and activating a privacy protection function are set respectively.

Step 3: use stage: the “hidden file folder” is opened by means of a combination lock or “gesture recognition”, and an application to be protected is dragged into the file folder. If an application icon is moved after the user presets the accessing/activating gesture, it is only necessary to move the icon to a preset location first when an accessing/activating method of “gesture recognition” needs to be used.

Step 4: use stage: the application icon to which the “hidden file folder” is attached is pressed long and dragged according to a preset gesture path, and the private application is hidden, or the application icon to which the hidden file folder is attached is clicked, a combination lock path for activating privacy protection is inputted, and the private application is hidden in the same way.

Step 5: use stage: the user opens the “hidden file folder” by an access lock, and clicks on a “recovery” option in the file folder to recover the private application.

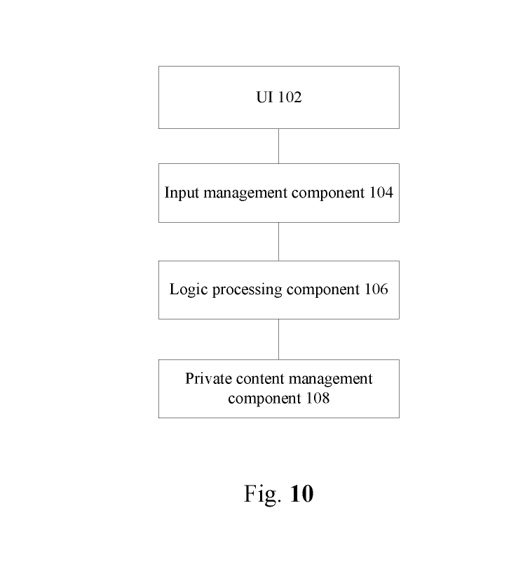

The method for rapidly hiding the private application may be implemented by the following structure. FIG. 10 is a structural block diagram of a device for quickly hiding a private application according to a preferred embodiment of the present disclosure. As shown in FIG. 10, the structure includes a User Interface (UI) 102, an input management module 104, a logic processing module 106 and a private content management module 108. The structure will be described below.

The input management module 104 is configured to monitor input on the UI 102 (such as a mobile phone desktop) and an “access control pattern lock”, and transmit an input content to the logic processing module 106.

The private content management module 108 is configured to maintain information of a private application designated by a user, when the user drags a desktop icon into a “hidden file folder”, the private content management module 108 generates data of the private application, and when the user drags an private application icon in the “hidden file folder” out of the file folder, the private content management module 108 deletes application information data. The private content management module 108 provides data support for the logic processing module 106.

The logic processing module 106 is responsible for analyzing a current operation of the user, judging whether there is an access/activation input consistent with the content, and processing a related process, including at least one of the followings.

If it is an operation of accessing the “hidden file folder”, the logic processing module 106 displays an interface of the “hidden file folder” through the UI.

If it is an operation of activating a “privacy protection function”, the logic processing module 106 stores a screenshot of information of current desktop application icons first, and then accesses the private content management module 108 to acquire information of a current application that requires privacy protection, deletes desktop icon information thereof from a database, then recalculates location information of remaining icons, while invoking the UI module to play an animation of “absorbing” the private application. The desktop icons are rearranged after the animation so that the screen is not in disorder.

If the user inputs an operation of “recovering a private application”, the logic processing module 106 invokes a desktop information screenshot stored last time, and recovers desktop icon information while invoking the UI module 102 to play an animation of “releasing” the private application. Desktop icons are recovered to a state before the protection after the animation.

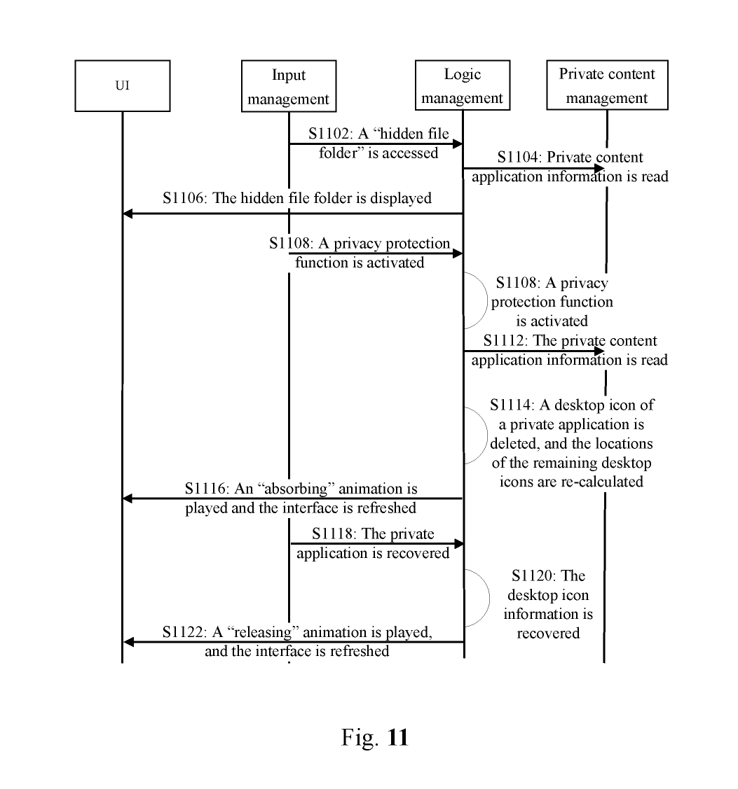

Sequential processing of rapidly hiding a private application in an embodiment of the present disclosure will be described below based on separate functions of the modules. FIG. 11 is a flowchart of sequential processing of quickly hiding a private application according to an embodiment of the present disclosure. As shown in FIG. 11, the flow includes the following steps.

Step 1102: The input management module 104 receives an input of the UI 102, accesses a hidden file folder, and transmits an inputted content to the logic processing module 106.

Step 1104: The logic processing module 106 reads information of an application of a private content from the private content management module 108.

Step 1106: The logic processing module 106 displays the hidden file folder to the UI.

Step 1108: The logic processing module 106 acquires a function of activating privacy protection from the input management module 104.

Step 1110: The logic processing module 106 generates a screenshot of desktop icon information.

Step 1112: The logic processing module 106 reads the information of the application of the private content from the private content management module 108.

Step 1114: The logic processing module 106 deletes a desktop private application icon, and re-calculates the locations of the remaining icons.

Step 1116: The logic processing module 106 plays an “absorbing” animation to the UI and refreshes the interface.

Step 1118: The logic processing module 106 receives the recovered private application from the input management module 104.

Step 1120: The logic processing module 106 recovers the desktop icon information.

Step 1122: The logic processing module 106 plays a “releasing” animation to the UI and refreshes the interface.

The whole solution gives adequate consideration to use experience of a user, and privacy protection can be provided quickly and concisely in use, thus satisfying a demand for privacy protection of the user in some emergency scenarios, and a “traceless” effect can be achieved after use so that other people are substantially imperceptible of some applications hidden in a mobile phone. Moreover, the flow is easy to implement and can be rapidly applied in mobile phone production.

Obviously, it should be understood by those skilled in the art that, the above modules or steps of the present disclosure may be implemented a universal computing device. They may be centralized on a single computing device or distributed on a network composed of multiple computing devices. Alternatively, they may be implemented by an application code executable by a computing device. Therefore, they may be stored in a storage device and executed by the computing device, and in same cases, the steps as illustrated or described may be executed according to sequences different from those herein, or they may be implemented by respectively fabricating them into integrated circuit modules, or by fabricating a plurality of modules or steps of them into a single integrated circuit module. Therefore, the present disclosure is not limited to any specific combination of hardware and software.

What are described above are only preferred embodiments of the present disclosure, but are not for use in limiting the present disclosure, and for those skilled in the art, there may be various modifications and changes to the present disclosure. Any modification, equivalent replacement, improvement and the like made within the spirit and principles of the present disclosure should be included in the protection scope of the present disclosure.

As described above, a method, device and terminal for processing a hidden file folder according to the embodiments of the present disclosure have the following beneficial effect: the problem that a private application of a user is hidden quickly without affecting usual use is solved by means of the present disclosure, thus implementing the effect of quickly and concisely protecting the privacy of the user.

1. A method for processing a hidden file folder, comprising:
determining an application icon to which the hidden file folder is to be attached;
creating the hidden file folder in a manner that the hidden file folder shares the application icon with a first application corresponding to the application icon, wherein an unlocking path used for visiting the first application is different from an unlocking path used for visiting the hidden file folder; and
storing in the hidden file folder a private application to be hidden.

2. The method as claimed in claim 1, wherein storing in the hidden file folder the private application to be hidden comprises:
selecting the private application to be hidden;
judging whether a hiding function is activated; and
when a judging result is that the hiding function is activated, storing in the hidden file folder the private application to be hidden.

3. The method as claimed in claim 2, wherein judging whether the hiding function is activated comprises:
receiving an input path;
judging whether the input path is matched with a preset activating path; and
when a judging result is that the input path is matched with the preset activating path, determining that the hiding function is activated.

4. The method as claimed in claim 1, after creating the hidden file folder in a manner that the hidden file folder shares the application icon with a first application corresponding to the application icon, further comprising:
setting an unlocking path for visiting other applications, wherein said other applications are applications corresponding to application icons except the application icon shared by the first application and the hidden file folder.

5. The method as claimed in claim 1, after creating the hidden file folder in a manner that the hidden file folder shares the application icon with a first application corresponding to the application icon, further comprising:
respectively deleting the first application or the hidden file folder according to different security locks, wherein the private application stored in the hidden file folder is recovered when the hidden file folder is deleted.

6. A device for processing a hidden file folder, comprising:
a determining component, configured to determine an application icon to which the hidden file folder is attached;
a creating component, configured to create the hidden file folder in a manner that the hidden file folder shares the application icon with a first application corresponding to the application icon, wherein a unlocking path used for visiting the first application is different from a unlocking path used for visiting the hidden file folder; and
a storing component, configured to store in the hidden file folder a private application to be hidden.

7. The device as claimed in claim 6, wherein the storing component comprises:
a selecting element, configured to select the private application to be hidden;
a judging element, configured to judge whether a hiding function is activated; and
a storing element, configured to, when a judging result is that the hiding function is activated, store in the hidden file folder the private application to be hidden.

8. The device as claimed in claim 7, wherein the judging element comprises:
a receiving sub-element, configured to receive an input path;
a judging sub-element, configured to judge whether the input path is matched with a preset activating path; and
a determining sub-element, configured to, when a judging result is that the input path is matched with the preset activating path, determine that the hiding function is activated.

9. The device as claimed in claim 6, further comprising:
a setting component, configured to set an unlocking path for visiting other applications, wherein said other applications are applications corresponding to application icons except the application icon shared by the first application and the hidden file folder.

10. The device as claimed in claim 6, further comprising:
a deleting component, configured to, respectively delete the first application or the hidden file folder according to different security locks, wherein the private application stored in the hidden file folder is recovered when the hidden file folder is deleted.

11. A terminal, comprising the device as claimed in claim 6.
